(19) United States
(12) Patent Application Publication
(10) Pub. No.: US 2005/0149434 A1
(43) Pub. Date: Jul. 7, 2005

(54) Method for endowing a tax exempt organization

(76) Inventor: John Selby, Palm Desert, CA (US)

Correspondence Address: LEYDIG, VOIT & MAYER, LTD.;(SEATTLE OFFICE), TWO PRUDENTIAL PLAZA, SUITE 4900, CHICAGO, IL, 60601-6780, US

(21) Appl. No.: 11/031,205

(22) Filed: Jan. 6, 2005

Related U.S. Application Data
(60) Provisional application No. 60/534,657, filed on Jan. 7, 2004.

(51) Int. Cl. G06F 17/60

(52) U.S. Cl. 705/38

(57) ABSTRACT

A method for establishing a contractually guaranteed and lucrative endowment fundraising program. The program utilizes a third party lender, such as a bank, that finances a premium for a life insurance policy. The life insurance policy is owned by the tax-exempt organization for the life of a key person of the tax-exempt corporation. Interest on the loan for the life insurance policy is paid by assets of the tax-exempt organization, and may be paid, for example, by yearly donations by the key member for which the policy is taken, to the general account, or by others. Collateral for the loan may be a combination of the cash surrender value of the life insurance policy and a deposit of assets of the tax-exempt organization with the bank. The deposit may be, for example, an investment management account opened with the bank.

### REFERENCE TO RELATED APPLICATION

This patent application claims priority to U.S. provisional Patent Application No. 60/534,657, filed Jan. 7, 2004, incorporated herein in its entirety.

### TECHNICAL FIELD OF THE INVENTION

The present invention relates to methods for generating endowments for tax-exempt organizations, and more specifically to the use of a life insurance policy to generate an endowment for the tax-exempt organization.

### BACKGROUND OF THE INVENTION

A tax-exempt organization, such as a non-profit organization, typically requires a large amount of operating capital to fund its mission and to pay its day-to-day operating expenses. The capital typically comes from donors, and often comes from a few key donors, such as board members of the tax exempt organization. One problem that tax-exempt organizations have to address is how to replace the present and future economic benefit lost upon the death of one or two key members of the tax-exempt organization. The key member or members may have provided a substantial source of revenue for the tax-exempt organization in the form of donations. In addition, when the key member or members die, it is often difficult to replace the non-monetary contributions, such as volunteer time or fundraising that was contributed by the key member(s).

Another problem that constantly must be addressed by tax-exempt organizations is how to provide a reliable source of revenue to build and sustain the tax-exempt organization's endowment and to do so without depleting funds, programs, and services that the tax-exempt organization provides. If the funds, programs, and services were depleted, it would diminish the tax-exempt organization's ability to act in the public interest.

### SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

In accordance with an embodiment, a method is provided for establishing a contractually guaranteed and lucrative endowment fundraising program. In accordance with an embodiment, the program is established largely from within the organization and relies minimally on outside donations and does not require the participation of outside individuals or legal entities to establish the program.

In accordance with an embodiment, the program utilizes a third party lender, such as a bank, that finances a premium for a life insurance policy. The life insurance policy is owned by the tax-exempt organization for the life of a key person of the tax-exempt corporation. Interest on the loan for the life insurance policy is paid by assets of the tax-exempt organization, and may be paid, for example, by yearly donations to the general account by the key member(s) for which the policy is taken, or by others. Collateral for the loan may be a combination of the cash surrender value of the life insurance policy and a deposit of assets of the tax-exempt organization with the bank. The deposit may be, for example, an investment management account opened with the bank.

As the cash surrender value of the life insurance policy grows, the bank or lender may begin a systematic yearly release of the investment management account back to the tax-exempt organization's general account. Alternatively, the investment management account may be held by the bank in full until such time as the loan is repaid, at which the investment management account is returned to the tax-exempt organization.

The tax-exempt organization may terminate the loan at any time by repaying the principal and any accrued interest to the bank. A loan exit strategy may be implemented by the tax-exempt organization borrowing against the cash surrender value of the life insurance policy and paying off the bank in whole or in part.

Other features of the invention will become apparent from the following detailed description when taken in conjunction with the drawings, in which:

### BRIEF DESCRIPTION OF THE DRAWINGS

FIG. 1 shows schematically participants in and establishment of a system and method in accordance with an embodiment of the invention;

FIG. 2 shows steps for establishing an endowment in accordance with an embodiment of the invention;

FIG. 3 shows schematically, similar to FIG. 1, participants in and maintenance of a system and method in accordance with an embodiment of the invention;

FIG. 4 shows a table of example death benefits utilizing an embodiment of the invention; and

FIG. 5 shows another table of example death benefits in accordance with an embodiment.

### DETAILED DESCRIPTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

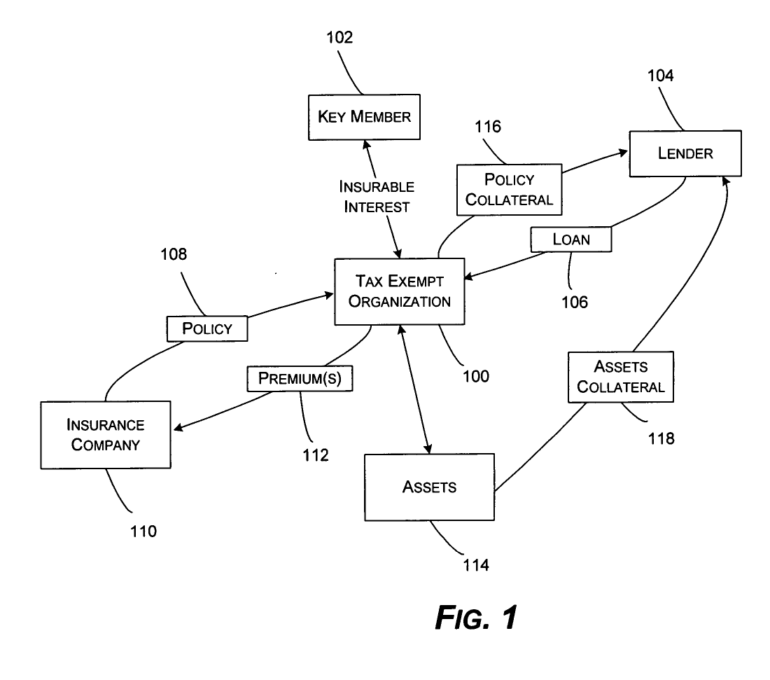

Referring now to the drawings, in which like reference numerals represent like parts throughout the several views, FIG. 1 shows schematically participants in a system and method in accordance with an embodiment of the invention (referred to by the assignee of the present invention as the KEY MEMBER ENDOWMENT model). The method involves a tax-exempt organization 100, such as a charitable organization or a non-profit corporation, having one or more key members 102.

“Key member” is used herein to mean an individual or individuals in which the tax-exempt organization 100 has an insurable interest. The key member 102 may, for example, be a board member of the tax exempt organization 100. Alternatively, the key member may be an officer or other person in which the tax-exempt organization 100 has an insurable interest. “Insurable interest” is a well known phrase in insurance law. In addition, key member, or key person insurance is known in the insurance industry.

In general, upon the death of such a key member, the tax-exempt organization 100 would lose a significant source of goodwill and/or on-going fundraising efforts that would produce significant gifts. In addition, the tax-exempt organization may lose ongoing donations that the key member might bestow. As such, in accordance with an embodiment, key member insurance is purchased to protect the tax-exempt organization from the loss of the key member or members, and to provide an endowment for the tax-exempt organization.

In accordance with an embodiment, a third party lender 104, for example a bank, provides a loan 106 to the tax-exempt organization 100. The tax-exempt organization 100 utilizes the loan 106 to purchase a life insurance policy 108 from a life insurance company 110. That is, the loan 106 is utilized to pay a premium or premiums 112 to the life insurance company 110.

In accordance with an embodiment, collateral for the loan 106 is provided at least in part by pledging the cash value of the life insurance policy 108. In addition, if desired, assets 114 of the tax-exempt organization 110 may be deposited with the lender 104 and may be maintained for the tax-exempt organization 100 while being used as collateral, as further described below.

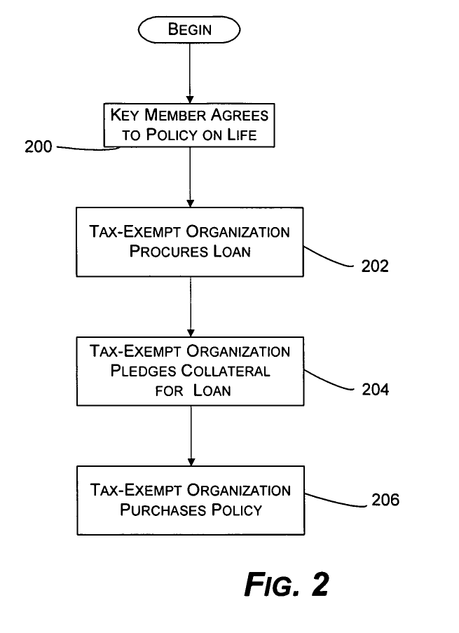

FIG. 2 shows steps for establishing a KEY MEMBER ENDOWMENT model in accordance with an embodiment. Beginning at step 200, a key member, such as a board member, agrees to the underwriting of a life insurance policy on his or her (or if plural, their) life. To simplify the description herein, the insurance policy, although it may be taken on multiple key members (for example with a second-to-die policy), will be described with respect to insuring a single key member 102.

At step 202, the tax-exempt organization 100 procures a loan. As part of this process, at step 204, the tax-exempt organization 100 pledges collateral for the loan. The loan may be any suitable loan, but in accordance with an embodiment is a non-amortized loan. In accordance with another embodiment, the loan is fully collateralized. In accordance with yet another embodiment, the loan has a term of ten years. Having a loan non-amortized and fully collateralized provides a stable situation for a lender such as a bank, thus providing incentive for the lender to supply the loan and to provide better interest rates. The significance of a ten year term is discussed below.

As collateral for the loan, the tax-exempt organization 100 may pledge the cash surrender value of the life insurance policy 108 to be purchased, indicated generally at 116 in FIG. 1. In addition, in accordance with an embodiment, investment assets, such as the assets 114, are pledged for remaining collateral 118 needed. These assets may be provided, for example, in the form of an investment management account that is opened with the lender 104. If an investment management account is used, for example at a bank, the investment management account is managed by the bank's private banker and funded by the transfer of assets from the assets 114 of the tax-exempt organization. The tax-exempt organization 100 maintains ownership of the investment management account as well as discretionary control over any investment management decisions.

Assuming a favorable underwriting experience for the key member 102, the lender 104 lends the loan 106 at step 202 against the collateral 116 and 118, and permitting the tax-exempt organization 100 to purchase an insurance policy 108 at step 206. Preferably, the insurance company 110 has an A plus or better rating with Standard & Poor's, and more preferably a rating of double A or better. A higher rated life insurance company may provide an opportunity for obtaining better interest rates with the lender 104 or may be mandatory as a requirement by the lender 104 for obtaining the loan 106.

The tax-exempt organization 100 purchases the insurance policy 108 and is the sole owner and sole beneficiary of the policy. In an embodiment, the policy is a single premium policy, but alternatively may include multiple premiums. Preferably, the insurance policy 108 is a modified endowment contract (MEC) life insurance policy, which often requires a single premium 112 or no more than the number of sufficient premiums to create a modified endowment contract based on the cash accumulation test or the premium guideline test. It is preferred that the life insurance policy 108 be characterized as a modified endowment contract by the Internal Revenue Service and state taxing agencies. A definition is provided by 26 U.S.C. Section 7702(A), and it is intended that the definition and application of the MEC to the present invention change with any changes to that definition.

A modified endowment contract is advantageous in that it carries a larger cash value than most insurance policies. However, any fixed universal life contract may be used, and a variable life contract could work, although it is significantly more risky. Preferably, the life insurance policy 108 has a contractually guaranteed minimum crediting rate and does not lapse with a guaranteed death benefit to the insured to the age 100 and beyond. If desired, if multiple key members 102 are involved, a second-to-die or similar life insurance policy may be procured.

To avoid any questions regarding ownership of the insurance policy 108, the premium 112 is preferably paid directly by the tax-exempt corporation after receiving the loan 106. In addition, the loan collateral requirements, such as the cash surrender value collateral 116 of the life insurance policy 108 and the assets collateral 118, are preferably posted directly by the tax-exempt organization 100.

To maintain appropriate separation and to avoid the appearance of self-dealing, no officer of the tax-exempt organization 100 or member of the board of directors of the tax-exempt organization including the key member 102 should be an affiliated person to the lender 104 or sit on the lender's board of directors or have an ownership interest in the lender other than a casual outside investment in the lender's common stock.

Similarly, to avoid the appearance of self-dealing, no officer of the tax-exempt organization 100 or member of the board of directors of the tax-exempt organization including the key member 102 should be an affiliated person to the life insurance company 110 or sit on the life insurance company's board of directors or have an ownership interest in the life insurance company other than a casual outside investment in the life insurance company's common stock.

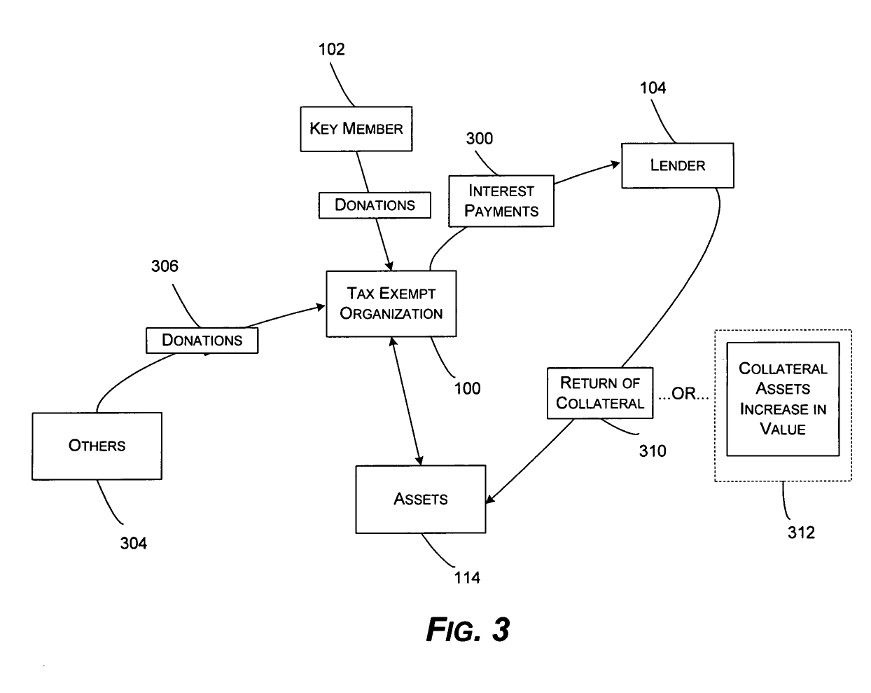

In accordance with an embodiment, the loan 106 may include an interest roll-up, so that no additional payments are made during the life of the loan. However, such a loan may be costly, especially where the key member 102 lives a long period of time. In accordance with another embodiment, interest payments are made on the loan 106 throughout the life of the loan. An example of the payment of interest payments 300 is shown in FIG. 3. In accordance with FIG. 3, interest payments 300 are paid out of the assets 114 of the tax-exempt organization 100. If desired, the assets 114 may be replenished by the key member 104 in the form of donations 302 to the general account. Donations 304 may also be made by other individuals 306 to the general account, which may or may not be key members. Additionally and/or alternatively, the interest payments 300 may be made out of a general fund including the assets 114. Thus, the interest payments 300 may come from a variety of sources, but in an embodiment, the donations 302 to the general account by the key member 102 are equal to the interest payments 300, thus making the net cost of the insurance policy 108, and maintenance of that policy, with the exception of a modest annual investment management fee charged by the lender while assets are under management, virtually zero for the tax-exempt organization.

As the cash surrender value of the life insurance policy 108 grows, the lender 108 may no longer require as much additional collateral (e.g., of the assets collateral 118). As such, in accordance with an embodiment, the lender 104 may begin a systematic early release of the investment management account or other assets pledged as assets collateral 118 back to the tax-exempt organization's assets 114. Each year as the cash surrender value of the insurance policy 108 increases, the lender 104 returns some of the collateral 310 (FIG. 3) to the tax-exempt organization 100. This returned collateral 310 may then again be part of the assets 114 of the tax-exempt organization. Eventually, all collateral separate from the cash surrender value of the insurance policy 108 (e.g., the assets collateral 118) may be returned to the general account as assets 114 of the tax-exempt organization 100. The cash surrender value of the insurance policy 108 may then become the sole collateral for the loan 106. This arrangement is made possible by the ongoing growth of the insurance policy's cash surrender value and remains in effect so long as the loan to debt ratio established at the loan's inception is maintained.

As an alternative to the yearly return of assets 310 shown in FIG. 3, as shown in the dashed box 312, the lender 104 may maintain the assets, such as the investment management account, and the value of those assets may increase. The assets still remain, however, owned by the tax-exempt organization 100.

In accordance with an embodiment, the tax-exempt organization 100 may terminate the loan 106 at any time by repaying the principle and any accrued interest to the lender 104. A loan exit strategy may be provided for this function. In accordance with one such exit strategy, when the cash surrender value of the insurance policy 110 exceeds the amount owed on the loan 106, the tax exempt organization 100 may borrow against the cash surrender value of the insurance policy 108 and pay-off the lender 104 in whole or in part. This method may also be used before the cash surrender value of the insurance policy 110 exceeds the amount owed on the loan 106 to pay off the lender in part. In accordance with an embodiment, the tax-exempt organization 100 leaves enough cash surrender value in the insurance policy 108 to keep the insurance policy strong and in force. By borrowing against the insurance policy's cash surrender value, the tax-exempt organization 100 trades a higher interest rate with the lender 104 for a lower interest rate with the life insurance company 110 in the form of a policy loan. The tax-exempt organization 100 may pay the interest due on the policy loan with funds from the assets 114.

Upon the death of the key member 102, the tax-exempt organization 100 receives a gift or an endowment with net of repayment of the loan 106. Some examples of scenarios are given below.

### EXAMPLE 1

The first example illustrates the purchase of a $22,766,240.00 joint life insurance policy 108 on the lives of two key members 102 of a tax-exempt organization's board of directors, Mr. Board Member and Ms. Board Member, each age 70. In this example, there is a single premium 112 of ten million dollars ($10,000,000). The tax-exempt organization is both the owner and beneficiary of the policy.

The tax-exempt organization assigns the policy's cash value to the lender as partial collateral 116 for the loan 106. As additional collateral, the tax-exempt organization assigns appropriate assets collateral 118 in the amount of $2,716,000.00 to the lender and agrees to the lender's management of those assets. Such assets may include equity securities, bonds, mutual funds, cash equivalents, and under certain circumstances, real estate holdings. The tax-exempt organization retains ownership of these assets and reserves the right of approval relative to all asset management decisions.

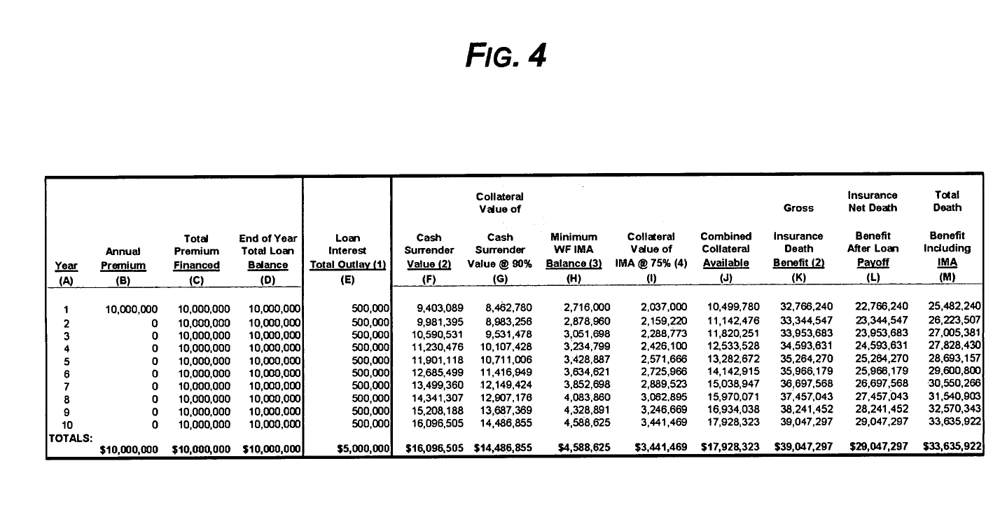

FIG. 4 illustrates a scenario wherein all loan collateral remains assigned to the lender. The scenario shows the net total death benefit for years one through ten of the plan. The assumptions are that the lender provides 90% collateral value for the cash surrender value of the life insurance policy (the policy collateral 116) and 75% collateral value for the assets (assets collateral 118) that are deposited with the lender, in this case in an investment management account (IMA). Other assumptions are that the interest rate on the loan is 5%, and that the non-guaranteed cash surrender value and death benefit assume a 5.9% crediting rate. In addition, an estimated growth rate of 6% is provided for the investment management account.

### EXAMPLE 2

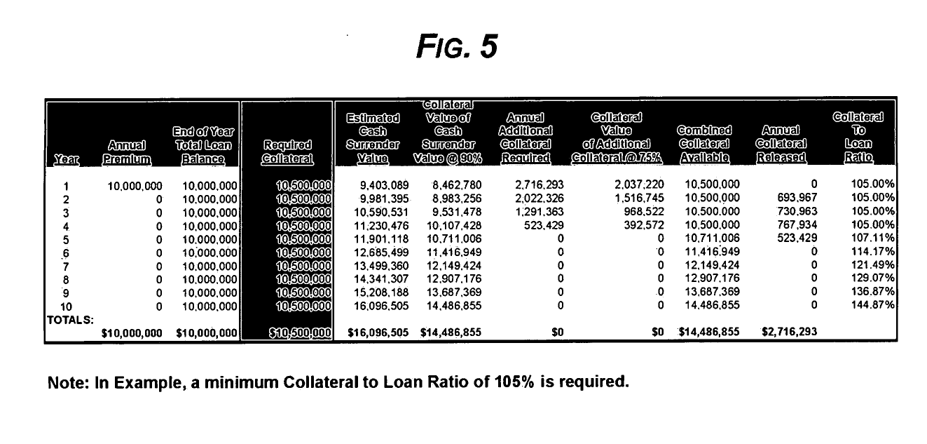

FIG. 5 shows a second scenario, similar to example 1, in which the excess additional collateral (the assets collateral 118) is released from assignment and returned to the policy owner. The same assumptions are used in this scenario.

After the ten year period shown in the scenarios in FIGS. 4 and 5, the tax-exempt organization 100 may pay off the loan 106, which would result in the release of the assignment of the investment management account (in scenario one where it still exists), and would result in the net equity in the cash surrender value of the policy 108 being reduced by the amount needed to pay off the loan. Thus, in scenario one in FIG. 4, the cash surrender value of the policy would be $6,096,505.00, but the loan balance would be $0.00. A policy loan is created and interest payments 300 on the policy loan are made to the insurance company 110, and may be minimal. Of course, the loan 106 may remain with the lender, but interest rates would be higher and growth of the total net death benefit will be reduced.

A benefit of financing the premium versus a traditional method of actually having an outlay of the amount of the premium is that the money that would be the initial outlay can be invested and the tax-exempt organization benefits from the growth of that investment. Moreover, the initial outlay may not be available for the tax-exempt organization.

Tax Implications

The Method successfully navigates through the federal and state tax laws relating to exempt organizations and income tax, penalty tax, unrelated business income tax and unrelated debt income tax and the laws associated with private benefit and inurement, excess benefit, self-dealing, and insurable interest.

As it relates to IRC Section 501(c)(3), Income Tax and/or Penalty Tax is not associated with the tax-exempt organization's receipt of the key member's death benefit proceeds from this arrangement because of its tax-exempt status.

As it relates to IRS Publication 598, Unrelated Business Income is not associated with the tax-exempt organization's receipt of the death benefit proceeds because the arrangement is not a trade or business, is not regularly carried on, and is substantially related to and contributes importantly to the accomplishment of the exempt purposes of the organization as it insures against the economic loss of services including fundraising, good will, and guidance and leadership for the direction and spirit of the organization upon the death of the key member(s).

As it relates to IRS Publication 598, Unrelated Debt Income is not associated with the tax-exempt organization's receipt of the death benefit proceeds because the arrangement does not involve acquisition indebtedness associated with debt-financed property including rental real estate, tangible personal property or corporate stock and is substantially related to and contributes importantly to the accomplishment of the exempt purposes of the organization as it insures against the economic loss of services including fundraising, good will, and guidance and leadership for the direction and spirit of the organization upon the death of the key member(s).

As it relates to the IRS Manual, Private Benefit or Inurement are dealings between a Non-Profit and a disqualified person by providing a benefit to the disqualified person and are acceptable as long as those dealings are at arm's length, in good faith, and reasonable and is not associated with this arrangement as there is no economic benefit to the key member(s) other than an allowable tax deduction available for charitable contributions to a Non-Profit should the key member(s) choose to participate in making charitable contributions.

As it relates to IRS Publication 557, Excess Benefit is generally exclusive to dealings between 501(c)(3) private foundations and disqualified persons and is not associated with this arrangement as there is no economic benefit to the key members(s) other than an allowable tax deduction available for charitable contributions to a Non-Profit should the key member(s) choose to participate in making charitable contributions.

As it relates to IRS Publication 578, Self-Dealing is generally exclusive to dealings between 501(c)(3) private foundations and disqualified persons and is not associated with this arrangement as there is no: 1) sale, exchange, or leasing of property; 2) lending money or other extensions of credit; 3) providing goods, services, or facilities; 4) paying compensation or reimbursing expenses to a disqualified person; 5) transferring foundation assets to, or for the use or benefit of, a disqualified person; or 6) agreements to make payments of money or property to government officials.

As it relates to life insurance contract law, Insurable Interest that must exist at the time the policy is purchased and is demonstrated in a relationship when a business entity has an insurable business interest in a key person's life and would suffer a financial loss or other kinds of losses upon that person's death is clearly associated with this method.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventor for carrying out the invention. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method of endowing a tax-exempt organization, comprising:
the tax-exempt organization procuring a loan from a lender; and
the tax-exempt organization utilizing the loan to finance a premium for a life insurance policy on the life of a key member of the tax-exempt organization, the life insurance policy to be owned by the tax-exempt organization.

2. The method of claim 1, wherein the loan is a non-amortized loan.

3. The method of claim 1, wherein the loan is a fully collateralized loan.

4. The method of claim 3, wherein the loan is at least partially collateralized by a cash surrender value of the life insurance policy.

5. The method of claim 4, wherein the loan is at least partially collateralized by an account opened with the lender and funded from assets of the tax-exempt organization.

6. The method of claim 5, further comprising, as the cash surrender value of the life insurance policy grows, releasing a portion of the assets back to the tax-exempt organization.

7. The method of claim 6, further comprising a periodic releasing of a portion of the assets back to the tax-exempt organization as the cash surrender value grows.

8. The method of claim 7, further comprising continuing the releasing until all assets are released back to the tax-exempt organization.

9. The method of claim 7, wherein the periodic releasing is based at least in part upon maintaining a loan to debt ratio requirement of a lender of the loan.

10. The method of claim 5, wherein the account is an investment management account.

11. The method of claim 3, wherein the loan is at least partially collateralized by an account opened with the lender and funded from assets of the tax-exempt organization.

12. The method of claim 11, wherein the account is an investment management account.

13. The method of claim 1, wherein the life insurance policy comprises a modified endowment contract life insurance policy.

14. The method of claim 13, wherein the life insurance policy comprises a single premium.

15. The method of claim 1, wherein the life insurance policy is purchased on the lives of two key members of the tax-exempt organization.

16. The method of claim 15, wherein the two key members are board members of the tax-exempt organization.

17. The method of claim 1, wherein the key member is a board member.

18. The method of claim 1, further comprising:
creating a policy loan to reduce the interest burden from the lender's loan to the tax-exempt organization.

19. The method of claim 18, wherein borrowing against the cash surrender value of the life insurance policy is used to pay the lender's loan off in part or in full.

20. The method of claim 1, wherein a policy loan is created to reduce the interest burden from the lender's loan.

21. The method of claim 20, wherein the payments are interest only.

22. The method of claim 1, wherein the life insurance policy is purchased on the life of one and only one key member of the tax-exempt organization.

23. A method of endowing a tax-exempt organization, comprising:
the tax-exempt organization procuring a non-amortizing, fully collateralized loan from a lender; and
the tax-exempt organization utilizing the loan to finance a premium for a modified endowment contract life insurance policy on the life of a key member of the tax-exempt organization, the modified endowment contract life insurance policy to be owned by the tax-exempt organization.

24. The method of claim 23, wherein the loan is at least partially collateralized by the cash surrender value of the modified endowment contract life insurance policy.

25. The method of claim 23, wherein the loan is at least partially collateralized by an account opened with the lender and funded from assets of the tax-exempt organization.
